(19) United States
(12) Patent Application Publication
(10) Pub. No.: US 2014/0329005 A1
(43) Pub. Date: Nov. 6, 2014

(54) SUPERCRITICAL DEPOSITION OF PROTECTIVE FILMS ON ELECTRICALLY CONDUCTIVE PARTICLES

(71) Applicants: BRIAN NELTNER, Somerville, MA (US); RICK BRYAN WOODRUFF, BOULDER, CO (US)

(72) Inventors: BRIAN NELTNER, Somerville, MA (US); RICK BRYAN WOODRUFF, BOULDER, CO (US)

(73) Assignee: MICROREACTOR SOLUTIONS LLC, Somerville, MA (US)

(21) Appl. No.: 14/265,678

(22) Filed: Apr. 30, 2014

Related U.S. Application Data
(60) Provisional application No. 61/818,122, filed on May 1, 2013.

(51) Int. Cl. H01B 13/00

(52) U.S. Cl. CPC H01B 13/0026
USPC 427/124; 427/58; 427/126.5; 427/126.3; 427/126.6

(57) ABSTRACT

A method for depositing a thin film of a coating material onto an electrically conductive particle surface via supercritical fluid deposition includes providing electrically conductive particles, providing a precursor of a coating material, dissolving the precursor of the coating material into a supercritical fluid solvent to form a supercritical solution of the precursor and subsequently exposing the conductive particles to the supercritical solution in a reactor under conditions at which supercritical fluid deposition of a thin film of the coating material onto surfaces of the conductive particles occurs.

### CROSS REFERENCE TO RELATED CO-PENDING APPLICATIONS

This application claims the benefit of U.S. provisional application Ser. No. 61/818,122 filed on May 1, 2013 and entitled SUPERCRITICAL DEPOSITION OF PROTECTIVE FILMS ON ELECTRICALLY CONDUCTIVE PARTICLES, which is commonly assigned and the contents of which are expressly incorporated herein by reference.

### FIELD OF THE INVENTION

The present invention relates to the use of supercritical fluid deposition to deposit electrically conductive thin films of protective materials onto the surface of electrically conductive particles.

### BACKGROUND OF THE INVENTION

There are several techniques used for depositing thin films onto the surface of a substrate, including electrostatic coupling, chemical coupling, surface place exchange reactions, physical vapor deposition, chemical vapor deposition, and atomic layer deposition, among others. These techniques may also be used for depositing coatings onto particles with various degrees of success.

Electrostatic coupling is a process wherein by maintaining a carefully controlled pH between the isoelectric points of the substrate and the depositing material, such that the depositing material when nucleated preferentially coats the substrate. Although this process is relatively inexpensive it is generally done in water and does not necessarily result in dense conformal coatings. Thus, it is unsuitable for corrosion prevention. Furthermore, the presence of water during coating is likely to result in oxide contamination. This technique also involves complicated particle separation techniques for removing the coated particles from the solution.

Chemical coupling is a process wherein a chemical linking agent is used to cause binding between the precursor and the substrate. An example is the use of mercaptopropyltrimethoxysilane to coat a metallic surface and provide silane suitable for nucleation of silica with trimethoxysilane. This technology is capable of producing core-shell structures that may be dense, but incorporates organic contaminants into a layer between the core and shell resulting in unsuitable electrical performance. This technique also involves complicated particle separation techniques for removing the coated particles from the solution.

Surface place exchange reactions involve the direct reaction of a precursor with a chemically active surface. An example of this would be the use of copper particles and silver nitrate solution. In principle, the silver nitrate is acidic and attacks the copper surface oxides while place exchanging silver for copper to produce a surface of silver along with copper nitrate in water solution. In our trials, this technique did not result in uniform coatings suitable for withstanding attack from oxygen in air at moderate temperatures. This technique is also slow, and involves complicated particle separation techniques for removing the coated particles from the solution.

Physical vapor deposition (PVD) is a process wherein a coating material is boiled under vacuum and the vapor condenses on the surface of the target. This process is unsuitable because it requires line of site (preventing coating of all sides uniformly), is not suitable for ready scale up to large volumes, as the coating material will deposit on any channels designed to carry the precursor to a particle chamber. This technique also generally deposits very thick films, and deposits so quickly that particle agglomeration is very likely.

Chemical vapor deposition (CVD) is a process wherein a coating chemical under vacuum is introduced into a chamber containing the target substrate. A chemical reaction at the surface of the substrate results in the coating chemical being converted to the desired thin film at the surface. This technique is widely used in the semiconductor industry for coating flat surfaces. In a particle coating application the concentrations of precursors are so low due to the vacuum that concentration gradients across the empty space between particles is severe. This inconsistency results in diffusion limited growth of films, and result in highly inconsistent film growth depending on where particles are located in the reactor. This both limits the size of scale up of such a system and also reduces the uniformity of grown films meaning a thicker target film is required to guarantee film performance. Finally, chemical vapor deposition requires a precursor which will break down thermally and which has a vapor pressure suitable for the reaction.

Atomic layer deposition (ALD) is a process wherein multiple steps are used to take a low concentration precursor under vacuum and deposit it monolayer by monolayer. For example, in a first stage an organometallic compound such as ferrocene partially reacts with a surface to form a self-passivating film of precursor molecules. The ferrocene does not react with itself, so after enough of the precursor is introduced to completely coat all surfaces, the reaction stops. In a second stage, a second reactant such as water is introduced to convert the ferrocene to iron oxide, regenerating the surface for a repeating of the first step of ferrocene deposition. By separating the deposition into two stages, a workaround is developed in which despite severe concentration gradients during diffusion limited deposition, the self-passivating nature of the deposition causes uniform monolayer thick film production. This process is highly limited in available precursors, is extremely slow, and scale up technologies to large production scales are not readily available.

Accordingly there is a need for an inexpensive, fast and scalable method for depositing conformal protective coating films on electrically conductive particles.

### SUMMARY OF THE INVENTION

This invention relates to the use of supercritical fluid deposition to deposit electrically conductive thin films such as ruthenium oxide, chrome oxide, and silver onto electrically conductive particles such as copper in the size range of 0.1-100 μm. The purpose of this digital alloy is to allow the use of an inexpensive or more electrically conductive particle in an environment in which it has unsuitable surface properties.

In general, in one aspect, the invention features a method for depositing a thin film of a coating material onto an electrically conductive particle surface via supercritical fluid deposition. The method includes providing electrically conductive particles, providing a precursor of a coating material, dissolving the precursor of the coating material into a supercritical fluid solvent to form a supercritical solution of the precursor and subsequently exposing the conductive particles to the supercritical solution in a reactor under conditions at which supercritical fluid deposition of a thin film of the coating material onto surfaces of the conductive particles occurs.

Implementations of this aspect of the invention may include one or more of the following. The electrically conductive particles may be copper, silver, nickel, aluminum, chromium or zinc. The electrically conductive particles have a size in the range of 0.01 micrometer to 100 micrometer. The coating material may an electrically conductive coating material, and the electrically conductive coating material may be ruthenium, niobium, molybdenum, chromium, zinc, cobalt, nickel, silver, platinum, gold, vanadium, tungsten, iron, rhodium, palladium, osmium, iridium, rhenium, tantalum, oxides thereof, multi-layer structures thereof, or alloys thereof. The coating material precursor comprises an organometallic precursor. The coating material precursor may be acetate, carbonate, chloride, citrate, cyanide, fluoride, nitrate, nitrite, phosphate, sulfate precursor, or the hydrates thereof. The coating material precursor is dissolved in a liquid solvent forming a liquid precursor solution prior to being dissolved into the supercritical fluid solvent. The liquid precursor solution is brought to supercritical pressure and temperature conditions of the supercritical fluid solvent prior to being dissolved into the supercritical fluid solvent. The electrically conductive particles are copper, the coating material includes chromium, and the precursor includes a chromium containing salt. The chromium containing salt may be chromium acetate, chromium carbonate, chromium chloride, chromium citrate, chromium cyanate, chromium fluoride, chromium nitrate, chromium nitrite, chromium phosphate, chromium sulfate, or the hydrates thereof. The electrically conductive particles are copper, the coating material comprises chromium, and the precursor comprises an organometallic precursor of chromium. The electrically conductive particles are copper, the coating material comprises silver, and the precursor comprises a silver containing salt. The silver containing salt may be silver acetate, silver carbonate, silver chloride, silver citrate, silver cyanate, silver fluoride, silver nitrate, silver nitrite, silver phosphate, silver sulfate, or the hydrates thereof. The electrically conductive particles are copper, the coating material comprises silver, and the precursor comprises an organometallic precursor of silver. The electrically conductive particles are copper, and the coating material comprises a bilayer coating comprising a layer of chromium and a layer of silver. The supercritical fluid solvent may be a non-polar supercritical solvent or a non-polar supercritical solvent with a co-solvent or an ionic liquid. The conditions at which supercritical fluid deposition of a thin film of the coating material onto the surfaces of the conductive particles occurs include conditions at which decomposition of the precursor occurs. The conditions at which supercritical fluid deposition of a thin film of the coating material onto the surfaces of the conductive particles occurs include conditions at which reaction of the precursor with the conductive particle surfaces or additional co-precursors occurs. The supercritical fluid may be a polar supercritical solvent comprising one or more molecules having dipole moment greater than 3×10⁻³⁰ C·m. The polar supercritical solvent may be ammonia, carbon monoxide, water, isopropanol, ethanol, methanol, butanol, formaldehyde, acetaldehyde, acetone, or diethyl ether. The supercritical fluid includes one or more of carbon dioxide, hydrogen, nitrogen, argon, chloroform, or a hydrocarbon comprising between one and ten carbon atoms. The hydrocarbon includes one or more of methane, ethane, propane, butane, pentane, hexane, heptane, octane, cyclopentane, cyclohexane, benzene or toluene. The non-polar supercritical solvent further includes a co-solvent or an ionic liquid comprising a molecule having a dipole moment greater than 3×10⁻³⁰ C·m. The co-solvent or ionic liquid includes one or more of water, isopropanol, ethanol, methanol, butanol, formaldehyde, acetaldehyde, acetone, or diethyl ether. The method further includes mixing a reaction reagent into the supercritical solution. The reaction reagent is also used to reduce the surfaces of the conductive particles and to remove oxide contaminations from said surfaces. The reaction reagent includes a reducing or oxidizing agent, and the reducing or oxidizing agent includes one or more of hydrogen, forming gas, methanol, ethanol, isopropanol, butanol, carbon monoxide, oxygen or water. The method may further include exposing the conductive particles to a reaction reagent in a separate stream from the supercritical solution. The may further include premixing a reaction agent with the supercritical solution at conditions where a chemical reaction involving the precursor is slow. The method may further include alternating exposing the conductive particles to the supercritical solution and to a reaction reagent in a separate stream from the supercritical solution. The reactor may be a fluidized bed reactor and the supercritical solution flows into the reactor with a velocity sufficient to form a fluidized bed of the conductive particles. The reactor may be a cross-flow moving bed reactor and the supercritical solution flows into the reactor with a velocity sufficient to form a partially fluidized bed and wherein the partially fluidized bed is configured to continually move downward. The reactor may be a continuous particle reactor and a lock hopper is used to pressurize the conductive particles and drop them into a stream of the supercritical solution. The precursor and the supercritical fluid solvent form a combined stream and the combined stream is injected directly into the reactor. The method may further include providing a supercritical fluid handling manifold and wherein the dissolving of the precursor of the coating material into the supercritical fluid solvent occurs in the supercritical fluid handling manifold and wherein the supercritical fluid handling manifold is configured to generate a combined stream of the supercritical fluid solvent mixed with the supercritical solution of the precursor at a controlled ratio.

In general, in another aspect, the invention features a method for depositing a thin film of chromium material onto a copper particle surface including providing copper particles, providing a precursor of a chromium material, dissolving the precursor of the chromium material into a supercritical fluid solvent to form a supercritical solution of the precursor, and subsequently exposing the copper particles to the supercritical solution in a reactor under conditions at which supercritical fluid deposition of a thin film of the chromium material onto surfaces of the copper particles occurs.

In general, in another aspect, the invention features a method for depositing a thin film of silver material onto a copper particle surface including providing copper particles, providing a precursor of a silver material, dissolving the precursor of the silver material into a supercritical fluid solvent to form a supercritical solution of the precursor, and subsequently exposing the copper particles to the supercritical solution in a reactor under conditions at which supercritical fluid deposition of a thin film of the silver material onto surfaces of the copper particles occurs.

Among the advantages of this invention may be one or more of the following. The use of supercritical fluid deposition to deposit electrically conductive thin films of protective materials onto the surface of electrically conductive particles in the size range of 0.1-100 μm, provides a combination of advantageous results including:
Pin-hole free coating to prevent oxidation with a thin coating.
Kinetically limited film growth instead of diffusion limited growth to ensure uniform film deposition over a large surface area.
Ability to use a wide variety of precursors such as silver and polar precursors.
Rapid film growth as compared with atomic layer deposition and chemical vapor deposition, suitable for scale up to large production quantities and on the order of tens of nanometers per minute.
Easy product separation without the need for complex particle separation technology, necessary for economical scale up to large production quantities.
Straightforward waste management, with straightforward routes to ensure that all precursors are fully reacted and the ability to use non-hazardous “green” supercritical solvents such as carbon dioxide to vastly reduce the use of expensive and toxic solvents.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is a schematic diagram of the supercritical deposition process for depositing Ruthenium on Copper, according to this invention;

FIG. 2 is a schematic diagram of the supercritical deposition system including the fluid handling manifold design, according to this invention;

FIG. 3 depicts Step One of Semi-Continuous Fluidized Bed Reactor;

FIG. 4 depicts Step Two of Semi-Continuous Fluidized Bed Reactor;

FIG. 5 depicts Step Three of Semi-Continuous Fluidized Bed Reactor;

FIG. 6 depicts Step Four of Semi-Continuous Fluidized Bed Reactor;

FIG. 7 depicts Step Five of Semi-Continuous Fluidized Bed Reactor;

FIG. 8 depicts Step Six of Semi-Continuous Fluidized Bed Reactor;

FIG. 9 depicts Step Seven of Semi-Continuous Fluidized Bed Reactor;

FIG. 10 depicts a Continuous Cross-Flow Moving Bed; and

FIG. 11 is a schematic diagram of a Continuous Particle Reactor.

### DETAILED DESCRIPTION OF THE INVENTION

This invention relates to the use of supercritical fluid deposition to deposit electrically conductive thin films such as ruthenium oxide, chrome oxide, and silver onto electrically conductive particles such as copper in the size range of 0.1-100 μm. The purpose of this digital alloy is to allow the use of an inexpensive or more electrically conductive particle in an environment in which it has unsuitable surface properties.

For example, in application to conductive inks, a thin coating of silver metal over a copper particle allows for a substantial reduction in silver content from 100% to 0.3% in the case of 100 μm particles while retaining necessary silver surface properties related to solderability, wettability in a binder, and surface oxidation. The copper particle alone would be unsuitable for this application as during heat treatment steps the copper metal would be converted to copper oxide, and further copper metal can poison semiconductors in a solar photovoltaic application. Thus, in this particular example the silver is serving a dual purpose of preventing copper oxidation while also improving surface properties in the specific application.

In supercritical fluid deposition a solid material is dissolved in a supercritical fluid solution at an elevated pressure and then the solution is rapidly expanded through an orifice into a region of relatively low pressure.

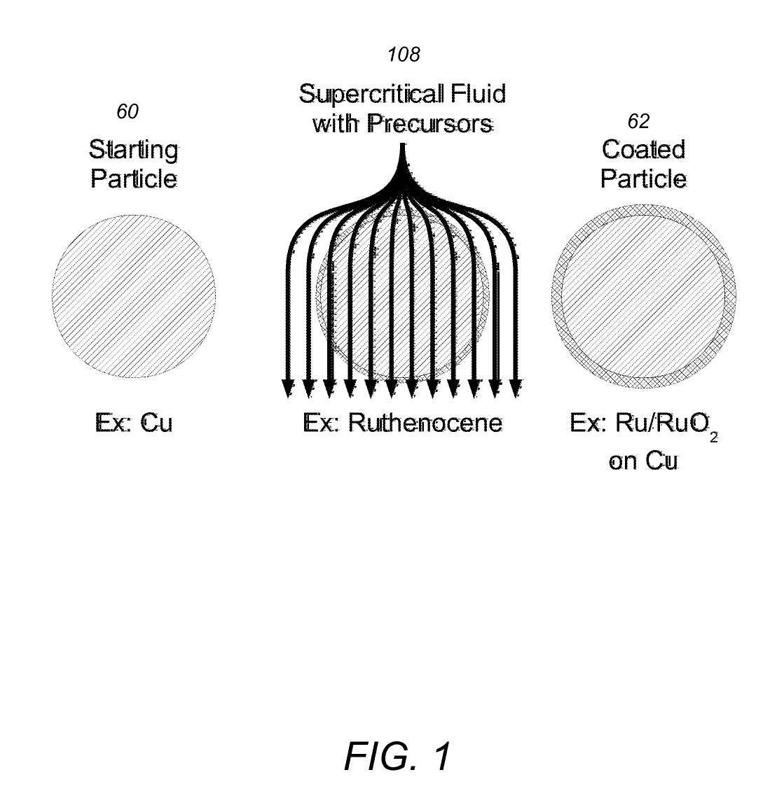

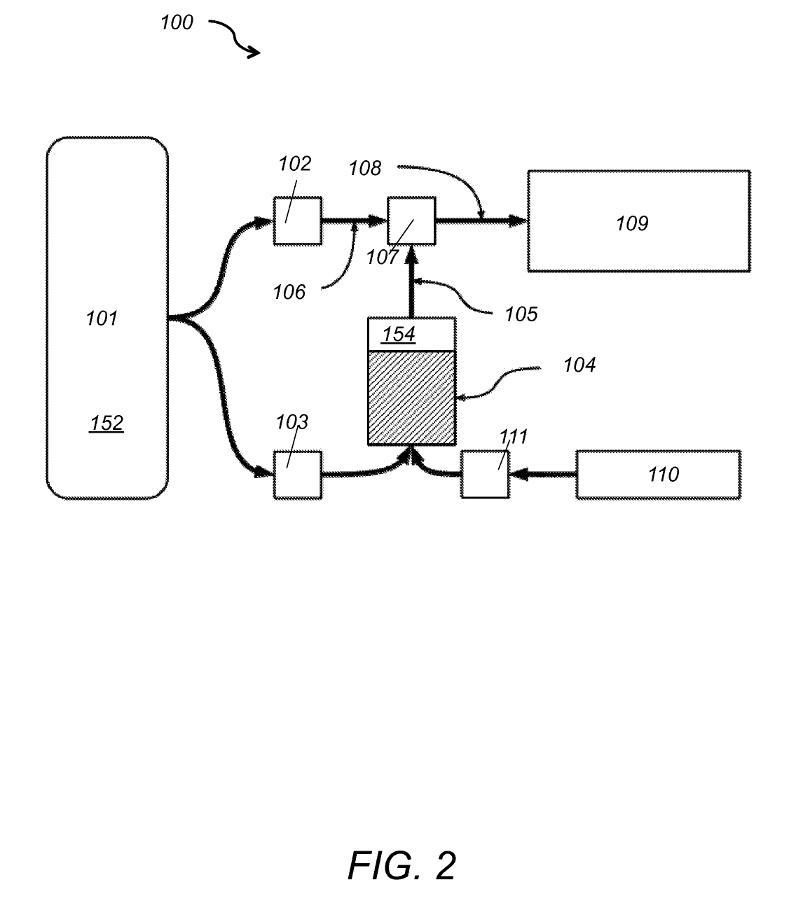

A schematic diagram of the supercritical fluid deposition process is shown in FIG. 1 for the example of ruthenium/ruthenium oxide deposition on copper particles. A schematic diagram of a supercritical fluid deposition system is shown in FIG. 2. Referring to FIG. 1 and FIG. 2, a supercritical fluid 101 contained in container 152 is used as a solvent for dissolving a precursor 104 contained in container 154, in order to produce a precursor stock solution 105. The supercritical fluid 101 is pumped with a high pressure pump 103 into the container 154 to generate a stream of the precursor stock solution 105. Supercritical fluid 101 is also pumped with a high pressure pump 102 to generate a stream 106 of supercritical fluid 101 without any precursor. Streams 105 and stream 106 flow into a mixing apparatus 107, where they are mixed to generate a solution 108 of unsaturated precursor in supercritical fluid. The concentration of the precursor in the supercritical fluid is controlled by controlling the flow rates of the two steams 105 and 106. Solution 108 flows into reactor 109 where it is mixed with particles 60 to produce coated particles 62. Co-solvents 110 may also be added into steam 105 of the precursor stock solution 104 by pumping them into the container 154 via pump 111. More detail including reaction temperatures, particle sizing, film thickness, film composition, particle composition, reaction time, and reactor design is included in later sections.

### Summary of Process Design:

This invention provides an apparatus and a process for the continuous or semi-continuous deposition of thin conformal films onto particles using supercritical fluid deposition. Four reactor designs are discussed herein, which can be categorized as follows:
1. Semi-Continuous Fluidized Bed
2. Continuous Cross-Flow Moving Bed
3. Continuous Particle Reactor
4. Manifold Free Reactor

A fluidized bed reactor is a reactor used to carry out multiphase chemical reactions. In a fluidized bed reactor a fluid passes through a solid particle type material at high enough velocities to suspend the particles and cause them to behave like fluid. The fluid may be gas or liquid. In the present application the fluid is a supercritical fluid solution.

The semi-continuous fluidized bed describes a system wherein a supercritical solvent is the fluid used to produce a fluidized bed for supercritical fluid deposition. The supercritical fluid also carries the solvent for the coating material. After a fixed reaction time, flow is shifted to remove particles from the reactor and new particles are placed in the reactor. By carefully controlling the precursor concentration, temperature, flow rate, and by potentially recycling outlet gas it is possible to achieve 100% precursor utilization, simplifying waste management and improving economics.

The continuous cross-flow moving bed describes a system similar to the fluidized bed where the flow rate is insufficient to cause fluidization. In this system, instead of mixing particles in the reactor, flow from below coats the particles but leaves them undisturbed. Cross-flow at the bottom is used to remove particles at the bottom of the moving bed while a lock hopper is used to periodically add fresh particles to the bed from the top. In this way, residence time is determined by the size of the bed and the rate of particle removal from the bottom. By carefully controlling the precursor concentration, temperature, flow rate, and by potentially recycling outlet gas it is possible to achieve 100% precursor utilization, simplifying waste management and improving economics.

The continuous particle reactor describes a system where a lock hopper is used to pressurize and if necessary preheat particles and drop them into a stream of supercritical solvent carrying precursors for a desired film composition. Upon mixing of high surface area particles and the precursors in the supercritical solvent, film deposition occurs on the particle surface. Residence time can be easily varied by controlling the flow rate of solvent or the length of the reactor zone in order to achieve a desired film thickness. By controlling precursor concentration, temperature, and flow rate it is possible to ensure that all precursors are completely reacted at the outlet, simplifying waste management and improving economics.

In the first three of the above cases, there is a common fluid handling manifold (shown in FIG. 2) to provide a metered and uniform continuous feed of precursor necessary for film deposition. This manifold allows supercritical carbon dioxide to dissolve a precursor and introduce it into the system with a good level of consistency.

In the “Manifold Free Reactor” design, this manifold is instead replaced with an external precursor injected directly into the reactor through the use of a pump. As an example, bis(ethylcyclopentadienyl)ruthenium is a liquid organometallic ruthenium precursor which could be pumped directly into the system using a simple HPLC pump. Alternatively, a precursor such as bis(benzene)chromium is an inexpensive chromium organometallic which is readily soluble in organic solvents and is introduced using an HPLC pump. This allows a stream of supercritical or liquid CO₂ to be mixed directly with the needed precursors and directed to the particles together without the need for a separate saturation manifold.

Finally, we note that the use of a liquid reducing agent is beneficial for cleaning the surface of copper particles to provide a clean and high conductivity surface. For instance, isopropanol, at supercritical conditions, acts as a ready reducing agent. In place of hydrogen for any of the designs, a pump could introduce isopropanol or another reducing agent with no loss of functionality. This reducing agent could also be introduced simultaneously with the precursor if they are compatible, reducing the number of inputs.

Specific Area of Application:

In this specific embodiment, we consider the use of electrically conductive thin films on an electrically conductive substrate to produce a digital alloy with enhanced high temperature oxidation, corrosion resistance, or improved solderability/sinterability while maintaining good bulk electrical conductivity.

We can estimate the required resistivity of the thin film to achieve a digital alloy that performs well by considering a copper particle with a characteristic size of 100 μm. With a resistivity (p) of 1.68·10⁻⁸ Ω·m, a copper particle of that size would have a characteristic resistance given by

$$R = ρ \cdot \frac{l}{A}$$

where l is approximately 10 μm and A is approximately 100 μm². This equation gives a characteristic resistance of approximately 0.1 mΩ.

For our thin film, we can estimate a contact area with a size of 100 μm and a film thickness of 0.01 μm (10 nm) as a reasonable film thickness to achieve necessary corrosion resistance. This gives l of 0.01 μm and A of 10000 μm². We can then set a characteristic film resistance equal to approximately the resistance of the bulk particle. This gives a maximum resistivity value requirement for the film of approximately 10⁻⁴ Ω·m. Actual requirements may be more stringent in order to achieve adequate conductivity under non-ideal conditions.

Example systems which would be suitable to the reactor designs specified include electrically conductive oxide coatings, corrosion resistant metal coatings, corrosion resistant alloys, among others. The electrically conductive oxide coatings may be NbO (ρ≈1.10⁻⁷), RuO₂ (ρ≈3.10⁻⁷), MoO₂ (ρ≈6.10⁻⁷), CrO₂ (ρ≈2.10⁻⁶), TiO (ρ≈2.10⁻⁶), VO (ρ≈2.10⁻⁵), or WO₂ (ρ≈3.10⁻⁴). The corrosion resistant metal coatings may be Ruthenium, Chromium, Molybdenum, Zinc, Cobalt, Rhodium, Palladium, Silver, Osmium, Iridium, Platinum, Gold, Rhenium, Titanium, Niobium, Tantalum, Nickel, or Iron. Corrosion resistant alloys such as Inconel, Nichrome, or Stainless Steel are made from Chrome, Zinc, Molybdenum, Nickel, Iron, Cobalt, Magnesium, Copper, Aluminum, Titanium, Silicon, Carbon, Sulfur, Phosphorous, Boron or Niobium on a less expensive or higher electrical conductivity substrate, such as Copper, Silver, Nickel, or Aluminum. In this way, a core-shell structure is formed where the corrosion, oxidation resistance, wetting, and sintering properties of the film are retained while improving the electrical conductivity of the particle and/or reducing the cost as compared to using the film material alone.

In each of these cases, a digital alloy of two materials is used to achieve good electrical conductivity while realizing a secondary property—in this case, corrosion and oxidation resistance at elevated temperatures or improved solderability and wettability. The novelty in this specific embodiment is the use of supercritical fluid deposition to achieve a uniform, conformal film on the surface of this particle.

Compared to prior art technologies for forming thin films, supercritical fluid deposition is superior for the production of electronic materials. Supercritical fluid deposition has orders of magnitude higher precursor concentrations—high enough that film growth is limited by reaction rate at the surface instead of diffusion. This means that film growth is uniform everywhere in the reactor, achieving ALD levels of uniform film deposition with deposition rates vastly higher than CVD or PVD. Typical deposition rates for ruthenium oxide are on the order of 10 nanometers per minute. At this rate, residence times in the reactor are in the range of 1 to 10 minutes, a readily achievable and controllable time which is short enough to allow for extremely high throughputs and high scalability.

The basic supercritical fluid deposition mentioned in our embodiment can be enhanced through the use of a 2-step process similar to ALD, a process called supercritical ALD. In this process, a primary downside of ALD coatings, the slow deposition rate for large surface areas, is overcome due to the high concentration of precursor in solution. However, the two-step process provides the same highly uniform coatings as does ALD itself at a substantially higher rate.

The precursors which are suitable for supercritical fluid deposition are limited not by vapor pressure and reactivity but instead by solubility in a supercritical solvent. Supercritical solvents such as supercritical carbon dioxide can produce concentrations of non-polar precursors thousands of times higher than the concentration seen under vacuum at room temperature. Additionally, the use of solvents such as supercritical ammonia or other polar solvents allows for the use of inexpensive, environmentally benign, and less hazardous precursors such as nitrate salts where these would be completely unsuitable in standard vapor deposition processes. Finally, as compared to liquid phase depositions, the process is vastly more controlled to produce more consistent and uniform films, is easier to scale, and is much simpler to separate the final digital alloy product from the solvent after the reaction is completed.

This is the first demonstration of supercritical fluid deposition of electrically conductive films on electrically conductive particles for the purposes of improving surface corrosion and oxidation resistance at elevated temperature while maintaining good electrical conductivity or lowering materials cost.

### Fluid Handling Manifold Design:

The process of continuous supercritical fluid deposition requires carefully metered precursor dissolved continuously in a supercritical solvent. This section describes a fluid handling manifold for two cases—ruthenium oxide coatings (supercritical carbon dioxide with hydrophobic precursor) and silver coatings (supercritical ammonia with hydrophilic precursor and supercritical carbon dioxide with co-solvent and hydrophilic precursor).

These should not be taken to reduce generality of the approach; other polar supercritical solvents can be used with other polar precursors, other non-polar supercritical solvents can be used with other non-polar precursors, and polar co-solvents can be used to increase the solubility of polar precursors in non-polar supercritical solvents. For example, non-polar supercritical solvents include Carbon Dioxide (T_{c}=304° K, P_{c}=7.4 MPa), Hydrocarbons such as Methane (T_{c}=190° K, P_{c}=4.6 MPa), Hydrogen (T_{c}=33° K, P_{c}=1.3 MPa), Nitrogen (T_{c}=127° K, P_{c}=3.4 MPa), among others. Polar supercritical solvents include Alcohols such as methanol (T_{c}=513° K, P_{c}=8.1 MPa), Ammonia (T_{c}=406° K, P_{c}=11.4 MPa), Water (T_{c}=647° K, P_{c}=22.1 MPa), Acetone (T_{c}=508° K, P_{c}=4.7 MPa), among others. Co-solvents which can be combined with a non-polar solvent such as supercritical carbon dioxide to dissolve polar precursors include Ethanol, Methanol, Water, Acetone, among others.

### Example 1

### Ruthenium Oxide Deposition

As a first example we describe the case of ruthenium oxide formation. In this case, supercritical carbon dioxide can be used directly as a solvent for a variety of hydrophobic precursors to provide a ruthenium precursor stock solution. Examples of hydrophobic precursors include Triruthenium dodecacarbonyl, Ruthenocene, Dicarbonyl cyclopentadiene ruthenium dimer, Tris-(2,2,6,6-tetrametyl heptane-3,5-dionato)ruthenium, or Bis(2,2,6,6-tetramethylheptane-3,5-dionato)-1,5 cyclooctadienylruthenium, among others.

Referring to FIG. 2, in a continuous system 100, a high pressure pump 102, 103 capable of handling liquid carbon dioxide is used in combination with a method to control flow to produce two independent streams of known flow rate supercritical carbon dioxide, as was described above. The high pressure pump 102, 103 may be a high performance liquid chromatography (HPLC) pump configured to prevent carbon dioxide evaporation in the pump head, Coriolis mass flow controller, syringe pump, or enthalpic mass flow controller with compensation. The method to control flow may be an orifice with known pressure drop, a flow controller, or an inherent control (HPLC/syringe pump). The first stream 106 is a flow of supercritical carbon dioxide with no precursor. The second stream flows into a chamber 154 containing the desired precursor 104 of ruthenium at a temperature such that the stream is supersaturated at a known ruthenium precursor concentration at the outlet. These two streams 105, 106 are mixed directly to achieve an arbitrary concentration of unsaturated precursor in supercritical carbon dioxide which is easily controlled by varying the relative flow rates in the two streams being mixed. Shutting down the second stream will result in no precursor in the output stream whereas shutting down the first stream will result in a saturated precursor output stream.

The continuous system 100 of FIG. 2 includes the liquid carbon dioxide feedstock 101, high pressure pump and flow control system operating at constant flow rate 102, high pressure pump and flow control system operating at constant flow rate 103, Ruthenium precursor 104 in heated saturation chamber 154, saturated supercritical carbon dioxide with ruthenium precursor 105, supercritical carbon dioxide with no precursor 106, mixing apparatus 107 to combine streams 106 and 105, output 108 with ruthenium precursor concentration based on relative flow rates of pumps 102 and 103, reactor 109 with particles 60 to be coated and other precursors if needed. The system may also include co-solvent addition 110 and co-solvent injection pump 111.

Typical temperature ranges for the saturation chamber are 31° C.-400° C. and are chosen such that the temperature is below the thermal decomposition temperature of the precursor while being above the supercritical temperature of carbon dioxide. The pressure of the system after high pressure pumps would typically be 7.4-52 MPa to achieve supercritical carbon dioxide conditions.

### Example 2

### Silver Metal Deposition without Co-Solvent

As a second example we describe the case of silver formation without a co-solvent. In this case, we consider the case of a polar silver precursor including silver nitrate, silver chloride, silver acetate, or silver sulfate, among others. These precursors are highly polar and readily dissolve in water. These prototypical polar precursors require a polar solvent such as those described above, or a co-solvent with a non-polar solvent as described above. In this case we will consider specifically the case of ammonia as a polar solvent without co-solvent.

In a continuous system 100, a high pressure pump capable of handling liquid ammonia is used in combination with a method to control flow to produce two independent streams of known flow rate supercritical ammonia. The high pressure pump 102, 103 may be an HPLC pump with pump head compatible with liquid ammonia, Coriolis mass flow controller, syringe pump, or enthalpic mass flow controller with compensation compatible with ammonia. The method to control flow may be an orifice with known pressure drop, a flow controller, or an inherent control (HPLC/syringe pump). The first stream is a flow of supercritical ammonia with no precursor. The second stream flows into a chamber containing the desired precursor of silver at a temperature such that the stream is supersaturated at a known silver precursor concentration at the outlet. These two streams are mixed directly to achieve an arbitrary concentration of unsaturated precursor in supercritical ammonia which is easily controlled by varying the relative flow rates in the two streams being mixed. Shutting down the second stream will result in no precursor in the output stream whereas shutting down the first stream will result in a saturated precursor output stream.

The continuous system 100 of FIG. 2 for this application includes the liquid ammonia feedstock 101, high pressure pump and flow control system operating at constant flow rate 102, high pressure pump and flow control system operating at constant flow rate 103, Silver precursor 104 in heated saturation chamber 154, saturated supercritical ammonia with silver precursor 105, supercritical ammonia with no precursor 106, mixing apparatus 107 to combine streams 106 and 105, output 108 with silver precursor concentration based on relative flow rates of pumps 102 and 103, reactor 109 with particles 60 to be coated and other precursors if needed. The system may also include co-solvent addition 110 and co-solvent injection pump 111.

Typical temperature ranges for the saturation chamber are 133° C.-400° C. and are chosen such that the temperature is below the thermal decomposition temperature of the precursor while being above the supercritical temperature of ammonia. The pressure of the system after high pressure pumps would typically be 11.4-52 MPa to achieve supercritical ammonia conditions.

### Example 3

### Silver Metal Deposition with Co-Solvent

As a third example we describe the case of silver formation with a co-solvent. In this case, we consider the case of a polar silver precursor including silver nitrate, silver chloride, silver acetate and silver sulfate, among others. These precursors are highly polar and readily dissolve in water. These prototypical polar precursors require a polar solvent such as those described above, or a co-solvent with a non-polar solvent as described above. In this case we will consider specifically the case of carbon dioxide as a non-polar solvent combined with ethanol as a co-solvent.

In the continuous system 100, a high pressure pump 102, 103 capable of handling liquid carbon dioxide is used in combination with a method to control flow to produce two independent streams of known flow rate supercritical carbon dioxide, as was described above. The high pressure pump 102, 103 may be a high performance liquid chromatography (HPLC) pump configured to prevent carbon dioxide evaporation in the pump head, Coriolis mass flow controller, syringe pump, or enthalpic mass flow controller with compensation. The method to control flow may be an orifice with known pressure drop, a flow controller, or an inherent control (HPLC/syringe pump). The first stream 106 is a flow of supercritical carbon dioxide with no precursor. The second stream of supercritical carbon dioxide is pumped through pump 103 and is mixed with the co-solvent 110 of ethanol in the supercritical state to form a supercritical solvent stream with the ability to solubilize polar precursors. This combined stream flows into chamber 154 containing the desired precursor of silver at a temperature such that the stream is supersaturated at a known silver precursor concentration at the outlet. These two streams 106, 105 are mixed directly to achieve an arbitrary concentration of unsaturated precursor in supercritical carbon dioxide which is easily controlled by varying the relative flow rates in the two streams being mixed. Shutting down the second stream will result in no precursor in the output stream whereas shutting down the first stream will result in a saturated precursor output stream.

The continuous system 100 of FIG. 2 includes the liquid carbon dioxide feedstock 101, high pressure pump and flow control system operating at constant flow rate 102, high pressure pump and flow control system operating at constant flow rate 103, silver precursor 104 in heated saturation chamber 154, saturated supercritical carbon dioxide with silver precursor and co-solvent 105, supercritical carbon dioxide with no precursor 106, mixing apparatus 107 to combine streams 106 and 105, output 108 with silver precursor concentration based on relative flow rates of pumps 102 and 103, reactor 109 with particles 60 and other precursors if needed. The system also includes ethanol reservoir 110 and ethanol co-solvent injection pump 111.

Typical temperature ranges for the saturation chamber are 31° C.-400° C. and are chosen such that the temperature is below the thermal decomposition temperature of the precursor while being above the supercritical temperature of ammonia. The pressure of the system after high pressure pumps would typically be 7.4-52 MPa to achieve supercritical ammonia conditions. Temperatures and pressure must be chosen appropriately to guarantee that the mixture of primary solvent and co-solvent remains supercritical. These conditions depend on the relative ratio of primary solvent and co-solvent.

It is notable that in the case of a liquid or liquid soluble precursor such as bis(ethylcyclopentadienyl)ruthenium or bis(benzene)chromium could be introduced into the system using a pump, bypassing the need for a manifold with a saturation chamber. This allows a stream of supercritical or liquid CO2 to be mixed directly with the needed precursors and directed to the particles together.

### Particle Reactor Design

After the fluid handling manifold, the stream 108 containing both precursor and supercritical solvent at a controlled ratio comes into contact with the conductive particles 60 in reactor 109 as specified above along with a second precursor if needed. This section contains four reactor designs to allow the scale-up of coated particle production from a small scale batch process in an autoclave to the production of tons of powder per month.

In these examples we will consider the use of copper particles in the size range of 0.1 μm-100 μm. Copper particles in this size range have the advantage of a comparatively small surface to volume ratio as compared to nanoparticular copper (<0.1 μm diameter) requiring a smaller amount of coating material to cover the surface to the same thickness. For instance, for a film of 50 nm thickness, the volumetric ratio of film material to particle material is shown in Table 1. This shows a decrease in the percentage of the film material in the digital alloy from 87.5% at 0.1 μm down to just 0.3% at 100 μm.

TABLE 1
Volumetric Film Concentration versus Particle Size

| Particle Diameter (μm) | Film Volume Percent |
|---|---|
| 0.001 | 100.00% |
| 0.005 | 99.99% |
| 0.01 | 99.92% |
| 0.05 | 96.30% |
| 0.1 | 87.50% |
| 0.5 | 42.13% |
| 1 | 24.87% |
| 5 | 5.77% |
| 10 | 2.94% |
| 50 | 0.60% |
| 100 | 0.30% |

It is desirable to have a small amount of film material relative to the total material because the film material is typically more expensive than particle material, and is often (as in the case of ruthenium oxide on copper) less conductive than particle material. Neither of these are always the case, for instance in the coating of silver onto copper where the coating is more conductive than the particle material (but much more expensive).

In all cases, particles of copper can be held at the reaction temperature under high pressure in an atmosphere containing hydrogen. These conditions will pre-reduce the particle surface and remove oxide contamination as well as to provide excess hydrogen as a reducing agent for reduction driven deposition of the precursors. Pre-heating the particles will also mean that the reaction of particles with precursor stream will happen immediately upon contact instead of requiring a period of time for the reactants to reach full temperature.

Alternatively, the use of a liquid reducing agent for cleaning the surface of copper particles to provide a clean and high conductivity surface may be done instead of using hydrogen, decreasing the cost and complexity of design. For instance, isopropanol, at supercritical conditions, acts as a ready reducing agent. In place of hydrogen for any of the designs, a pump could introduce isopropanol or another reducing agent with no loss of functionality. This reducing agent could also be introduced simultaneously with the precursor into the manifold if they are compatible, reducing the number of inputs.

Although the specific reaction conditions will depend on the precursor being used—three examples of which are described above—a typical temperature of reaction would be between 150° C. and 400° C. at a pressure adequate for reaching supercritical conditions. A typical target film thickness would be between 5 nm and 50 nm.

Below we describe four different reactors which can be used at different scale up sizes in order to achieve continuous or semi-continuous production of particles coated via supercritical fluid deposition. In these cases we will use the example of ruthenium oxide coatings on copper particles, but this should not be taken to reduce the generality of materials choices described.

### Semi-Continuous Fluidized Bed

The semi-continuous fluidized bed has a number of substantial advantages over other types of systems. These advantages include the following. The fluidized bed has excellent mixing, resulting in uniform particle coverage. It is easy to use for batch processing as well as continuous processing to improve consistency in scale up. Large volume of particles can be simultaneously coated for large throughput per batch.

The overall process is described in seven generalized stages. It is understood that some of these stages can be easily combined in order to increase overall throughput—in particular it is readily possible to operate the fluidized bed while refilling the particle lock hopper and removing product from the collection chamber, and purge steps can potentially be removed depending on the system.

It is understood that the heater can be turned on and off or varied in temperature arbitrarily, so long as the reactor is at the desired reaction temperature during fluidized bed deposition. It is also understood that in all cases where gravity driven particle transfer is specified, pressure assisted transfer can also be used.

It is also specifically understood that in place of hydrogen gas, another reducing agent such as supercritical isopropanol or even no reducing agent at all may be used.

It is also specifically understood that it is possible to alternate injection a reducing or oxidizing agent alternating with precursor containing the coating compound in order to achieve a 2-step supercritical ALD process. This process would involve, for instance, coating with a material that self-passivates on the surface, introducing supercritical isopropanol to convert to metal, and then repeating this process until the desired overall film thickness is achieved. This alternating precursor and reducing/oxidizing agent process can be taken to substitute anywhere in these processes coating step (Step One).

### Step One: Fluidized Bed Coating

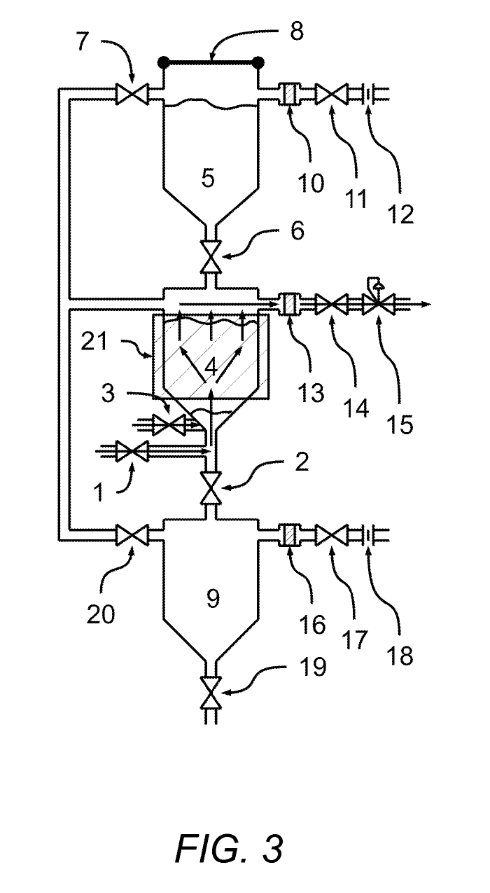

Referring to FIG. 3, reactor system 109 includes valves 1, 2, 3, 6, 7, 11, 17, 19, 20, reactor vessel 4, particle lock hopper 5, lid for lock hopper 8, product collection vessel 9, particle filters 10, 13, 16, orifices 12, 18, back pressure regulator 15, and heater 21. Valve 1 provides an inlet from fluid handling manifold and allows supercritical solvent and precursor to flow. Valve 2 provides an inlet to the product collection vessel 9. Valve 3 provides an inlet for a hydrogen containing gas (for instance, forming gas) used as second reactant and for particle surface treatment. Hydrogen reduces surface copper oxide to copper metal and also acts as reducing agent if needed to convert precursor to ruthenium for deposition. In reactor vessel 4, combined flows from valves 1 and 3 produce a fluidized bed of copper particles. Particle lock hopper 5 has an upper chamber that may be at atmospheric pressure and contains copper particles. Valve 6 provides inlet to lock hopper upper chamber. Valve 7 provides inlet to vapor head space of lock hopper upper chamber. Lid 8 used to close the lock hopper upper chamber. Particle filters 10, 13, 16 are used to prevent clogging of valves. Orifices 12, 18 are used for flow restriction. Alternatively, a back pressure regulator may be used for flow restriction. Valve 20 provides an inlet to vapor head space of the product collection vessel 9. Heater 21 is used to both preheat copper particles and provide consistent reaction temperature.

In Step One, shown in FIG. 3, the coating step of the process is performed. In this step the state of the reactor is as follows:
Inlet from fluid handling manifold has an open valve 1 allowing supercritical solvent and precursor to flow.
Valve 2 to product collection vessel is closed.
Valve 3 from hydrogen containing gas (for instance, forming gas) flows as second reactant and particle surface treatment. Hydrogen reduces surface copper oxide to copper metal and also acts as reducing agent if needed to convert precursor to ruthenium for deposition.
In reactor vessel 4, combined flows from valves 1 and 3 produce a fluidized bed of copper particles.
Particle lock hopper upper chamber 5 may be at atmospheric pressure and contains copper particles.
Valve 6 to lock hopper upper chamber is closed.
Valve 7 to vapor head space of lock hopper upper chamber is closed.
Lid 8 of lock hopper upper chamber 5 is closed.
Product collection vessel 9 may be empty.
Particle filter 10 is used to prevent clogging of valves.
Valve 11 may be either open or closed.
Orifice 12 or other flow restriction such as back pressure regulator.
Particle filter 13 is used to prevent clogging of valves.
Valve 14 is open, allowing fluidized bed to exhaust.
Back pressure regulator 15 is configured to keep fluidized bed pressure constant.
Particle filter 16 is used to prevent clogging of valves.
Valve 17 may be either open or closed.
Orifice 18 or other flow restriction such as back pressure regulator.
Valve 19 may be either open or closed.
Valve 20 to vapor head space of product collection vessel is closed.
Heater 21 used to both preheat copper particles and provide consistent reaction temperature is active.

### Step Two: Purging Fluidized Bed of Precursors.

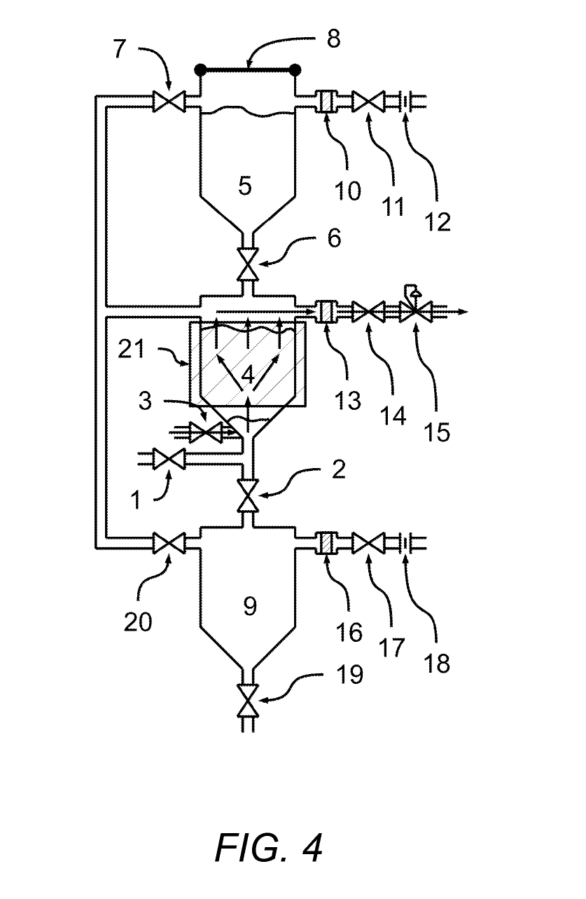

In Step Two, shown in FIG. 4, the reactor vessel 4 is purged of precursors. In this step the state of the reactor is as follows:
Inlet from fluid handling manifold through valve 1 is closed, preventing further flow of precursors.
Valve 2 to product collection vessel is closed.
Valve 3 from hydrogen containing gas (for instance, forming gas) flows as second reactant and particle surface treatment. Hydrogen reduces surface copper oxide to copper metal and also acts as reducing agent if needed to convert precursor to ruthenium for deposition. This gas is now also used to purge the reactor of residual precursors.
In reactor vessel 4, combined flows from valves 1 and 3 produce a fluidized bed of copper particles.
Particle lock hopper upper chamber 5 may be at atmospheric pressure and contains copper particles.
Valve 6 to lock hopper upper chamber is closed.
Valve 7 to vapor head space of lock hopper upper chamber is closed.
Lid 8 of lock hopper upper chamber is closed.
Product collection vessel 9 may be empty.
Particle filter 10 to prevent clogging of valves.
Valve 11 may be either open or closed.
Orifice 12 or other flow restriction such as back pressure regulator.
Particle filter 13 to prevent clogging of valves.
Valve 14 is open, allowing fluidized bed to exhaust.
Back pressure regulator 15 is configured to keep fluidized bed pressure constant.
Particle filter 16 to prevent clogging of valves.
Valve 17 may be either open or closed.
Orifice 18 or other flow restriction such as back pressure regulator.
Valve 19 may be either open or closed.
Valve 20 to vapor head space of product collection vessel is closed.
Heater 21 used to both preheat copper particles and provide consistent reaction temperature is active to react any remaining precursors.

### Step Three: Equalizing Pressures.

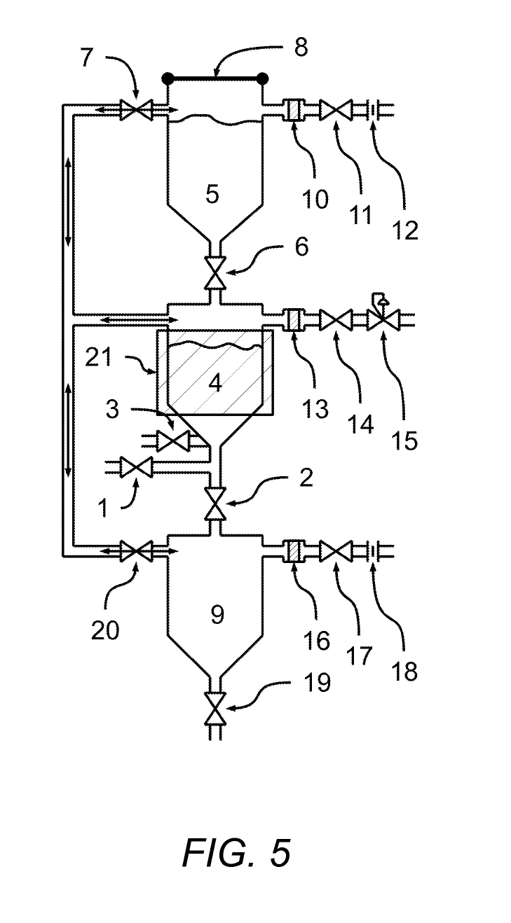

In Step Three, shown in FIG. 5, flow in the fluidized bed is stopped and pressures between the lock hopper, product collection chamber, and reactor chamber are equalized. In this step the state of the reactor is as follows:
Inlet from fluid handling manifold is through valve 1 is closed, preventing further flow of precursors.
Valve 2 to product collection vessel is closed.
Valve 3 from hydrogen containing gas is closed.
Static bed in reactor vessel 4 with no flow or fluidization settles.
Particle lock hopper upper chamber 5 is brought to equal pressure with reactor vessel.
Valve 6 to lock hopper upper chamber is closed.
Valve 7 to vapor head space of lock hopper upper chamber is open to allow pressure equilibration. This may be done in a different order, it just needs to happen before opening valve 6.
Lid 8 of lock hopper upper chamber is closed.
Product collection vessel 9 is empty, and is brought to equal pressure with reactor vessel.
Particle filter 10 to prevent clogging of valves.
Valve 11 is closed to allow pressurization of lock hopper.
Orifice 12 or other flow restriction such as back pressure regulator.
Particle filter 13 to prevent clogging of valves.
Valve 14 is closed.
Back pressure regulator 15 is configured to keep fluidized bed pressure constant.
Particle filter 16 to prevent clogging of valves.
Valve 17 is closed to allow pressurization of product collection chamber.
Orifice 18 or other flow restriction such as back pressure regulator.
Valve 19 is closed.
Valve 20 to vapor head space of product collection chamber is open to allow pressure equilibration. This can be done in a different order, it just needs to happen before opening valve 2.
Heater 21 is used to both preheat copper particles and provide consistent reaction temperature is active to maintain reactor temperature.

### Step Four: Emptying Reactor to Product Collection Chamber

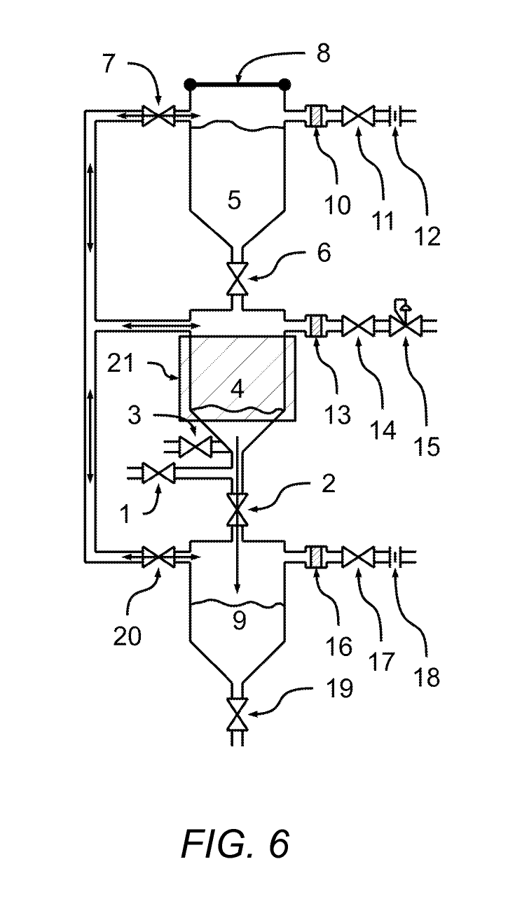

In Step Four, shown in FIG. 6, gravity is used to transfer particles from the reactor chamber 4 to the product collection chamber 9. In this step the state of the reactor is as follows:
Inlet from fluid handling manifold through valve 1 is closed, preventing further flow of precursors.
Valve 2 to product collection vessel is open, allowing flow of particles from reactor chamber to product collection chamber.
Valve 3 from hydrogen containing gas is closed.
Static bed in reactor vessel 4 is being emptied to product collection chamber 9.
Particle lock hopper upper chamber 5 is at equal pressure with reactor vessel.
Valve 6 to lock hopper upper chamber is closed.
Valve 7 to vapor head space of lock hopper upper chamber is open to allow pressure equilibration.
Lid 8 of lock hopper upper chamber is closed.
Product collection vessel 9 is being filled from reactor chamber.
Particle filter 10 to prevent clogging of valves.
Valve 11 is closed.
Orifice 12 or other flow restriction such as back pressure regulator.
Particle filter 13 to prevent clogging of valves.
Valve 14 is closed.
Back pressure regulator 15 is configured to keep fluidized bed pressure constant.
Particle filter 16 to prevent clogging of valves.
Valve 17 is closed.
Orifice 18 or other flow restriction such as back pressure regulator.
Valve 19 is closed.
Valve 20 to vapor head space of product collection chamber is open to allow pressure equilibration.
Heater 21 is used to both preheat copper particles and provide consistent reaction temperature is active to maintain reactor temperature.
   Step Five: Refill Reactor from Lock Hopper

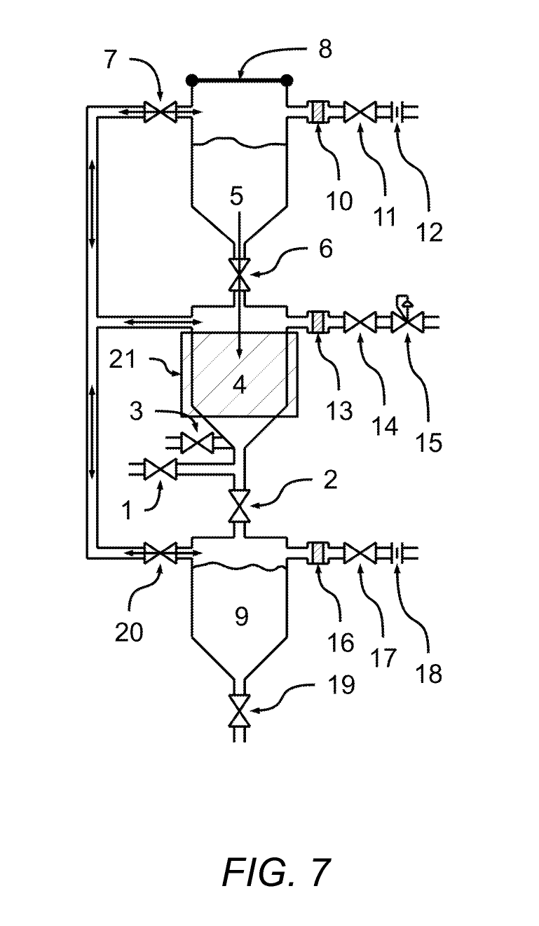

In Step Five, shown in FIG. 7, gravity is used to refill the reactor vessel 4 with particles from the lock hopper upper chamber 5 after the reactor is emptied of finished product. In this step the state of the reactor is as follows:
Inlet from fluid handling manifold through valve 1 is closed, preventing further flow of precursors.
Valve 2 to product collection vessel is closed.
Valve 3 from hydrogen containing gas is closed.
Reactor vessel 4 is empty of particles.
Particle lock hopper upper chamber 5 is being emptied to reactor chamber 4.
Valve 6 to lock hopper upper chamber is open, allowing flow of particles from lock hopper to reactor chamber.
Valve 7 to vapor head space of lock hopper upper chamber is open to allow pressure equilibration.
Lid 8 of lock hopper upper chamber is closed.
Product collection vessel 9 is full of product.
Particle 10 filter to prevent clogging of valves.
Valve 11 is closed.
Orifice 12 or other flow restriction such as back pressure regulator.
Particle filter 13 to prevent clogging of valves.
Valve 14 is closed.
Back pressure regulator 15 is configured to keep fluidized bed pressure constant.
Particle filter 16 to prevent clogging of valves.
Valve 17 may be opened if valve 20 is closed to depressurize product chamber 9.
Orifice 18 or other flow restriction such as back pressure regulator.
Valve 19 is closed.
Valve 20 to vapor head space of product collection chamber may be open or closed. If closed at this stage, valve 17 can be opened to depressurize product collection chamber 9.
Heater 21 is used to both preheat copper particles and provide consistent reaction temperature is active to maintain reactor temperature.

### Step Six: Depressurize Lock Hopper and Product Collection Chamber

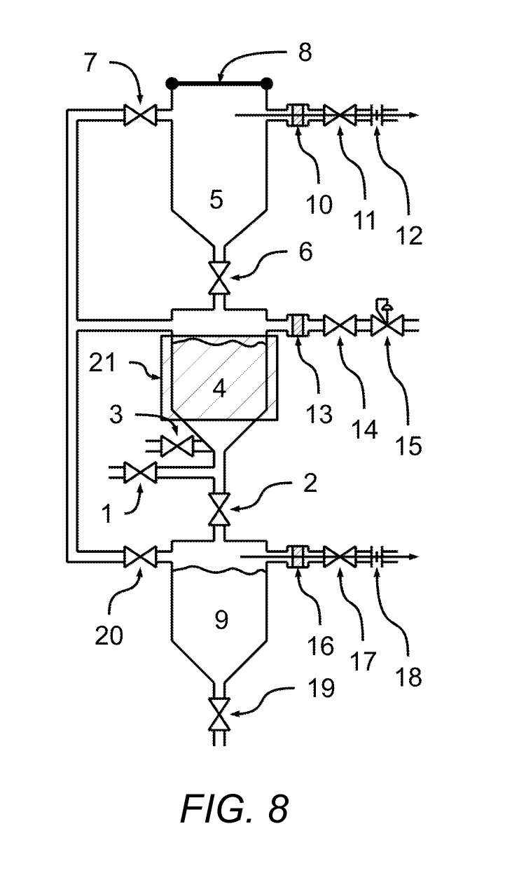

In Step Six, shown in FIG. 8, both the lock hopper 5 and product collection chamber 9 are depressurized. For either or both of these, the depressurization can happen simultaneously with other steps so long as valves 6 and 7 are closed for the lock hopper and valves 2 and 20 are closed for the product collection chamber. At this point, it is also fine to jump ahead for the reactor vessel 4 back to Step One and restart the fluidized bed deposition while depressurizing the lock hopper 5 and product collection chamber 9. In this step the state of the reactor is as follows:
Inlet from fluid handling manifold through valve 1 may be closed, but can also be moved back to Step One configuration at this time.
Valve 2 to product collection vessel is closed.
Valve 3 from hydrogen containing gas may be closed, but can also be moved back to Step One configuration at this time.
Reactor vessel 4 is full of particles and can be re-fluidized.
Particle lock hopper 5 is being depressurized through relief valve.
Valve 6 to lock hopper upper chamber is closed.
Valve 7 to vapor head space of lock hopper upper chamber is closed.
Lid 8 of lock hopper upper chamber is closed.
Product collection vessel 9 is full of product.
Particle filter 10 to prevent clogging of valves.
Valve 11 is open.
Orifice 12 or other flow restriction such as back pressure regulator.
Particle filter 13 to prevent clogging of valves.
Valve 14 may be closed, but can also be moved back to Step One configuration at this time.
Back pressure regulator 15 is configured to keep fluidized bed pressure constant.
Particle filter 16 to prevent clogging of valves.
Valve 17 is open.
Orifice 18 or other flow restriction such as back pressure regulator.
Valve 19 is closed.
Valve 20 to vapor head space of product collection chamber is closed.
Heater 21 is used to both preheat copper particles and provide consistent reaction temperature is active to maintain reactor temperature.

### Step Seven: Empty Product Chamber and Refill Hopper

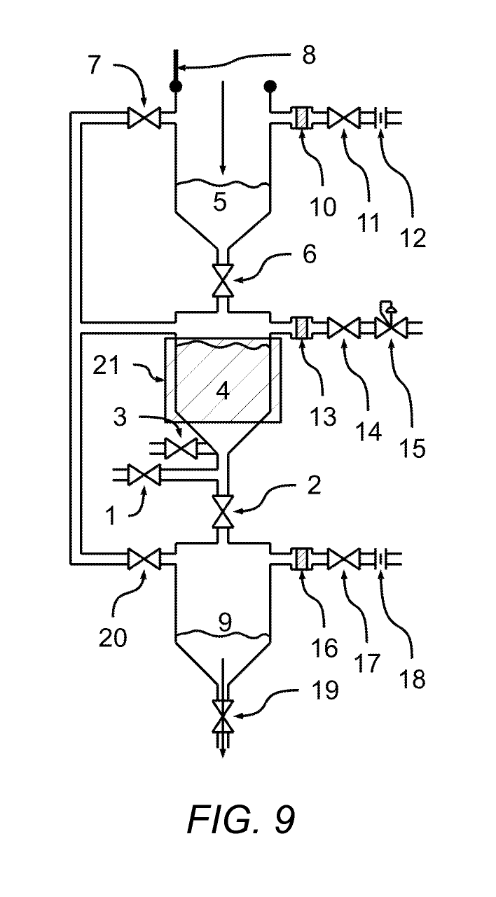

In Step Seven, shown in FIG. 9, the product collection chamber 9 is emptied of product and the lock hopper upper chamber 5 is refilled with atmospheric pressure particles. At this stage, the fluidized bed 4 can be active and coating if desired. In this step the state of the reactor is as follows:
Inlet from fluid handling manifold through valve 1 may be closed, but can also be moved back to Step One configuration at this time.
Valve 2 to product collection vessel is closed.
Valve 3 from hydrogen containing gas may be closed, but can also be moved back to Step One configuration at this time.
Reactor vessel 4 is full of particles and can be re-fluidized.
Particle lock hopper 5 is refilled with copper particles.
Valve 6 to lock hopper upper chamber is closed.
Valve 7 to vapor head space of lock hopper upper chamber is closed.
Lid 8 of lock hopper upper chamber is open to allow refilling. This is a generalized lid meant to indicate any opening suitable for pouring in particles, including a valve.
Product collection vessel 9 is emptied.
Particle filter 10 to prevent clogging of valves.
Valve 11 may be open or closed.
Orifice 12 or other flow restriction such as back pressure regulator.
Particle filter 13 to prevent clogging of valves.
Valve 14 may be closed, but can also be moved back to Step One configuration at this time.
Back pressure regulator 15 is configured to keep fluidized bed pressure constant.
Particle filter 16 to prevent clogging of valves.
Valve 17 may be open or closed.
Orifice 18 or other flow restriction such as back pressure regulator.
Valve 19 is open to retrieve product.
Valve 20 to vapor head space of product collection chamber is closed.
Heater 21 is used to both preheat copper particles and provide consistent reaction temperature is active to maintain reactor temperature.

In all cases, it is understood that pressure assisted particle transfer is readily achievable, and that alternative flow rate limiting devices such as pressure regulators and flow controllers can be used in place of an orifice. It is also understood that the secondary precursor stream is not necessary for all reactions. It is also clear that the pressurization process in this system may result in some precursors entering the addition lock hopper and product collection lock hoppers and that suitable hazardous waste management techniques may be necessary at all exhausts.

It is also understood that during pressure equilibration steps, the flow rate from the reactor to the other chambers must be kept sufficiently small so as to not cause pressure loss inside of the reactor. This can be accomplished with an orifice at the inlet to each chamber, or by active feedback based on the pressure in the reactor or the flow rate through the exhaust wherein the flow to the other chambers being pressurized is stopped if the flow from the exhaust stops. Pressurization of these chambers can be accelerated through the use of a secondary independent gas inlet easily.

### Continuous Cross-Flow Moving Bed

The continuous cross-flow moving bed has several advantages as compared to other approaches. Among the advantages of the continuous cross-flow moving bed may be one or more of the following.
It is continuous, meaning that in steady state it is likely to have consistent product output particularly as compared to a batch process.
It does not experience the delays that the semi-continuous reactor may have during product transfer steps.
It is vastly higher throughput as compared to a batch system.
All precursors can be completely reacted through the bed to reduce the complexity of waste management.

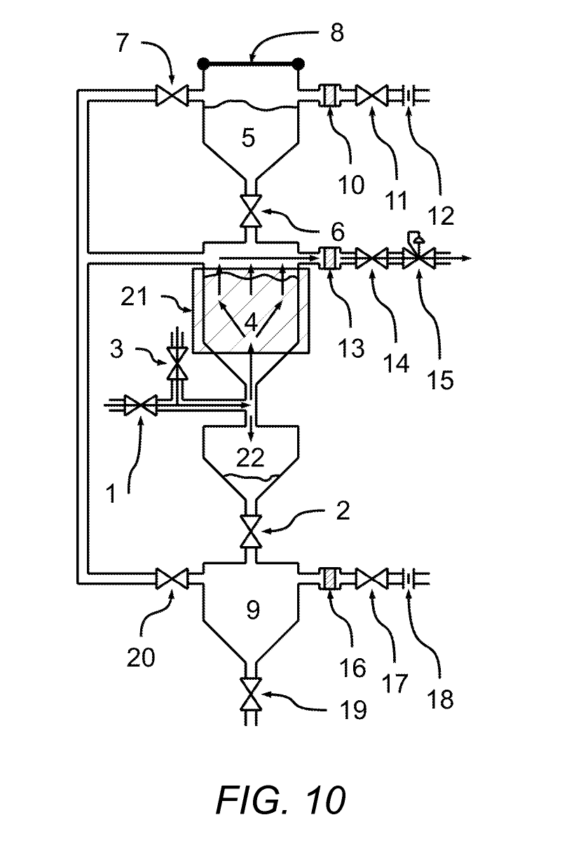

A schematic of the continuous cross-flow moving bed is shown in FIG. 10. The overall layout of this system is quite similar to that of the semi-continuous fluidized bed, with several major changes. Most importantly, instead of the stream of supercritical solvent and secondary precursor (for instance, hydrogen containing gas) being of sufficient velocity to produce a fluidized bed, the velocity is chosen such that the bed is only partially fluidized and is continually moving downwards (“moving bed”). The rate at which particles drop out of the reactor can be chosen based on the particle size, bed depth, overall flow rate, and density/viscosity selected based on supercritical solvent temperature and pressure.

As natural modifications necessary to accommodate a moving bed, an additional product capturing chamber 22 is placed below the reactor 4. As the moving bed falls, chamber 22 gradually fills up under pressure equivalent to that of the main reactor. In this first configuration, when 22 is filled it can be emptied into the product collection lock hopper 9. It is also potentially desirable to leave valves 2 and 20 open so that chamber 22 and by extension the main reactor 4 are continually emptying into a product collection lock hopper. In this second operating mode, when the product collection lock hopper 9 is full, valves 20 and 2 can be closed, valve 17 can be opened to relieve pressure inside of the product collection hopper 9, and after depressurization, valve 19 can be used to remove the product. After product removal, valves 19 and 17 can be closed, and valve 20 can be opened to equalize pressure between the product collection hopper 9 and the main reactor 4, followed by opening valve 2 to allow any product accumulated in 22 to be removed. It is also understood that this can be accomplished using pressure assistance. In this second operating mode, secondary product capturing chamber 22 can be quite small, needing only to accommodate that product produced in the time when the main product collection hopper is being emptied.

An additional natural modification required to accommodate a continuous process is refilling capability. A lock hopper 5 is filled with copper particles as needed at low pressure, and before refilling the main reactor 4 is pressurized by closing valve 11 while opening valve 7. Valve 6 is typically closed except when refilling the reactor. At a point before the bed reaches a low enough level that precursors are reaching the top of the moving bed, valve 6 is opened while pressurized to place fresh copper particles into the main reactor 4. The timing of this is designed so that fresh copper particles are exposed to reducing atmosphere hydrogen and preheated so that when the first begin encountering precursor they will be fully pre-treated and ready to be coated.

Finally, instead of hydrogen containing second precursor stream gas being injected directly into the reactor, the second gas would naturally be mixed with the primary precursor stream before flowing into the reactor to prevent clogging. This is not strictly necessary. During startup from a cold system, this hydrogen containing second precursor would be flowing exclusively to pre-treat the surface of the copper particles before the primary precursor is injected into the system.

All other elements of the reactor are used as described in the diagram for the semi-continuous fluidized bed. A back pressure regulator 15 is used to control the pressure inside the reactor, heater 21 is used to set the reactor temperature, and particle traps 10, 13, and 16 are used to prevent clogging of the exhaust valves. Orifices 12 and 18 are used to limit the rate of depressurization of the lock hoppers during addition of fresh copper and the removal of finished product. Valves 7 and 20 are used to pressurize and equilibrate the addition lock hopper and product collection lock hopper respectively, while valves 2 and 6 are used to close off the product collection lock hopper during product removal and to refill the reactor with fresh copper particles respectively.

In all cases, it is understood that pressure assisted particle transfer is readily achievable, and that alternative flow rate limiting devices such as pressure regulators and flow controllers can be used in place of an orifice. It is also understood that the secondary precursor stream is not necessary for all reactions. It is also clear that the pressurization process in this system may result in some precursors entering the addition lock hopper and product collection lock hoppers and that suitable hazardous waste management techniques may be necessary at all exhausts.

It is also understood that during pressure equilibration steps, the flow rate from the reactor to the other chambers must be kept sufficiently small so as to not cause pressure loss inside of the reactor. This can be accomplished with an orifice at the inlet to each chamber, or by active feedback based on the pressure in the reactor or the flow rate through the exhaust wherein the flow to the other chambers being pressurized is stopped if the flow from the exhaust stops. Pressurization of these chambers can be accelerated through the use of a secondary independent gas inlet easily.

It is understood that by injecting alternating coating compound containing streams and reducing/oxidizing agent streams at different locations along the reaction zone, it is possible to achieve supercritical ALD 2-step deposition.

### Continuous Particle Reactor

The continuous particle reactor is closest to a traditional continuous plug-flow style reactor wherein particles are mixed with precursors for coating and then carried through a reactor. This style of reactor has several advantages, including the following, among others.
Very well defined residence time controlled by the length of the reactor and the flow rate.
Continually moving and mixing particles increase homogeneity of coating.
Precursor concentration decreases along the length of the reactor, making it straightforward to guarantee that no remaining precursor is present at the outlet.

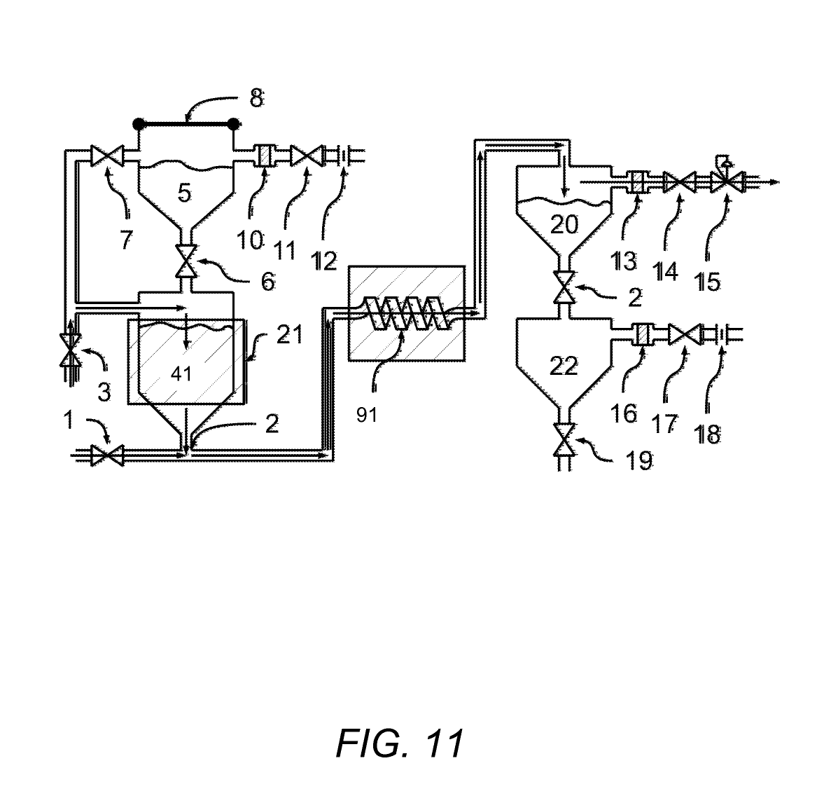

A schematic of the continuous particle reactor is shown in FIG. 11. In this continuous system, the inlet valve 1 carries a stream of supercritical solvent and precursor for the coating material. Inlet valve 3 carries the second precursor, for instance a hydrogen containing gas mixture. The second precursor, in the case of a hydrogen containing gas mixture, flows past copper particles held in the pressurized side of a lock hopper 4. The lock hopper can be pre-heated using furnace 21 if desired to cause more rapid initiation of reaction upon mixing with the stream of precursor from inlet valve 1. An excess of hydrogen containing gas flows through the particle bed and into the reaction stream.

Additionally, particles from hopper 41 are gravity fed and carried in the hydrogen containing gas stream into the mixing zone 2 where they combine with the precursor and supercritical solvent stream from inlet valve 1.

After mixing, the reaction immediately begins if the particles are pre-heated to the reaction temperature. This would be typical for most reactions. The particles, supercritical solvent, precursor, and second precursor are all carried simultaneously through a length of reactor 91 while held at the reaction temperature by a furnace. It is understood that in the drawing the furnace is drawn only around a spiral tube, but that the heated zone is likely to include the entire length of tubing in which the particles travel, as well as the zone prior to mixing to maintain the solvent in a supercritical state. It is also understood that the physical shape of the reactor is not constrained to be a spiral and can be a straight tube or any other complex shape so long as the reactor length satisfies the residence time requirements and so long as the tubing is possible to heat to a desired temperature profile.

After the reaction consumes all precursor, the final product plus byproducts from the reaction flow into product collection chamber 20. In this chamber, particles collect due to gravity at the bottom while gas flows through a particle filter 13 and a pressure regulation system 14 and 15. This backpressure regulator 15 controls the end pressure of the reactor, and nominally sets the entire reactor pressure assuming minimal pressure drop across the reactor itself. After the supercritical solvent and byproducts of the reaction flow through backpressure regulator 15, the solvent is expanded to produce in this example gaseous carbon dioxide and some hydrocarbon contaminants.

After product collection chamber 20 is full, it can be readily evacuated into product collection hopper 22 by opening valve 2. It is preferred that this is done with product collection hopper 22 at a pressure equal to the pressure in product collection chamber 20 to avoid rapid changes in the flow rate through the reactor or a pressure drop in the system. This can readily be accomplished through the use of a compressed gas and pressure regulator. After pressure equalization, valve 2 can be opened to transfer the finished product into product collection hopper 22. After product transfer, valve 2 can be closed in order to allow the opening of valve 17 to reduce pressure to a safe handling level after which valve 19 can be opened to remove the product. It is understood that during operation it is desirable to leave valve 2 open with both chambers 20 and 22 pressurized in order to reduce the impact of repressurization. Pressure balance between chambers 20 and 22 necessary after collecting the product in order to re-open valve 2 can be accomplished with, for instance, a differential pressure sensor and feedback controlled valve.

Similarly to the product collection system, the particle hopper 41 must be periodically refilled with copper particles to be reacted. This requires pressure equalization between particle hopper 41 and particle refill hopper 5. This pressure equalization must be done so that the flow rate of hydrogen containing gas through hopper 41 does not vary in order to guarantee that the flow rate through the reactor does not see variation. Additionally, the particle refill hopper 5 should be pressurized using the same hydrogen containing gas which is flowing through hopper 41 to avoid variations in the gas composition. This is most easily accomplished through the use of a differential pressure meter controlling a feedback controlled forward pressure regulator to hopper 5. This can be taken to be contained in valve 7. Valve 3 is shown as connected in series with the inlets to both hopper 41 and 5, but it is understood that the two inlets must be independent in order to allow pressure equalization without impacting the flow rate through particles in hopper 41.

It is understood that during pressure equilibration steps, the flow rate from the reactor or product collection chamber to other chambers must be kept sufficiently small so as to not cause pressure loss inside of the reactor. This can be accomplished with an orifice at the inlet to each chamber, or by active feedback based on the pressure in the reactor or the flow rate through the exhaust wherein the flow to the other chambers being pressurized is stopped if the flow from the exhaust stops. Pressurization of these chambers can be accelerated through the use of a secondary independent gas inlet easily.

After equilibration of pressure between hoppers 41 and 5, valve 6 can be opened to allow the transfer of particles from hopper 5 to hopper 41. After transfer, valve 6 and 7 can be closed and valve 11 opened to reduce the pressure in hopper 5 and allow safe refilling.

It is understood that by injecting alternating coating compound containing streams and reducing/oxidizing agent streams at different locations along the reaction zone, it is possible to achieve supercritical ALD 2-step deposition.

Several embodiments of the present invention have been described. Nevertheless, it will be understood that various modifications may be made without departing from the spirit and scope of the invention. Accordingly, other embodiments are within the scope of the following claims.

What is claimed is:

1. A method for depositing a thin film of a coating material onto an electrically conductive particle surface comprising:
providing electrically conductive particles;
providing a precursor of a coating material;
dissolving the precursor of the coating material into a supercritical fluid solvent to form a supercritical solution of the precursor; and subsequently
exposing the conductive particles to said supercritical solution in a reactor under conditions at which supercritical fluid deposition of a thin film of the coating material onto surfaces of the conductive particles occurs.

2. The method of claim 1, wherein the electrically conductive particles comprise copper, silver, nickel, aluminum, chromium or zinc.

3. The method of claim 1, wherein the electrically conductive particles comprise a size in the range of 0.01 micrometer to 100 micrometer.

4. The method of claim 1, wherein the coating material comprises an electrically conductive coating material, and wherein the electrically conductive coating material comprises ruthenium, niobium, molybdenum, chromium, zinc, cobalt, nickel, silver, platinum, gold, vanadium, tungsten, iron, rhodium, palladium, osmium, iridium, rhenium, tantalum, oxides thereof, multi-layer structures thereof, or alloys thereof.

5. The method of claim 1, wherein the coating material precursor comprises an organometallic precursor.

6. The method of claim 1, wherein the coating material precursor comprises one of acetate, carbonate, chloride, citrate, cyanide, fluoride, nitrate, nitrite, phosphate, sulfate precursor, or the hydrates thereof.

7. The method of claim 1, wherein the coating material precursor is dissolved in a liquid solvent forming a liquid precursor solution prior to being dissolved into the supercritical fluid solvent.

8. The method of claim 7, wherein the liquid precursor solution is brought to supercritical pressure and temperature conditions of the supercritical fluid solvent prior to being dissolved into the supercritical fluid solvent.

9. The method of claim 1, wherein the electrically conductive particles comprise copper, the coating material comprises chromium, and the precursor comprises a chromium containing salt.

10. The method of claim 9, wherein the chromium containing salt comprises one of chromium acetate, chromium carbonate, chromium chloride, chromium citrate, chromium cyanate, chromium fluoride, chromium nitrate, chromium nitrite, chromium phosphate, chromium sulfate, or the hydrates thereof.

11. The method of claim 1, wherein the electrically conductive particles comprise copper, the coating material comprises chromium, and the precursor comprises an organometallic precursor of chromium.

12. The method of claim 1, wherein the electrically conductive particles comprise copper, the coating material comprises silver, and the precursor comprises a silver containing salt.

13. The method of claim 12, wherein the silver containing salt comprises one of silver acetate, silver carbonate, silver chloride, silver citrate, silver cyanate, silver fluoride, silver nitrate, silver nitrite, silver phosphate, silver sulfate, or the hydrates thereof.

14. The method of claim 1, wherein the electrically conductive particles comprise copper, the coating material comprises silver, and the precursor comprises an organometallic precursor of silver.

15. The method of claim 1, wherein the electrically conductive particles comprise copper, and the coating material comprises a bilayer coating comprising a layer of chromium and a layer of silver.

16. The method of claim 1, wherein the supercritical fluid solvent comprises a non-polar supercritical solvent or a non-polar supercritical solvent with a co-solvent or an ionic liquid.

17. The method of claim 1, wherein said conditions at which supercritical fluid deposition of a thin film of the coating material onto the surfaces of the conductive particles occurs comprise conditions at which decomposition of the precursor occurs.

18. The method of claim 1, wherein said conditions at which supercritical fluid deposition of a thin film of the coating material onto the surfaces of the conductive particles occurs comprise conditions at which reaction of the precursor with the conductive particle surfaces or additional co-precursors occurs.

19. The method of claim 1, wherein the supercritical fluid comprises a polar supercritical solvent comprising one or more molecules having dipole moment greater than 3×10⁻³⁰ C·m.

20. The method of claim 19, wherein the polar supercritical solvent comprises ammonia, carbon monoxide, water, isopropanol, ethanol, methanol, butanol, formaldehyde, acetaldehyde, acetone, or diethyl ether.

21. The method of claim 16, wherein the supercritical fluid comprises one or more of carbon dioxide, hydrogen, nitrogen, argon, chloroform, or a hydrocarbon comprising between one and ten carbon atoms.

22. The method of claim 21 wherein the hydrocarbon comprises one or more of methane, ethane, propane, butane, pentane, hexane, heptane, octane, cyclopentane, cyclohexane, benzene or toluene.

23. The method of claim 21, wherein the non-polar supercritical solvent further comprises a co-solvent or an ionic liquid comprising a molecule having a dipole moment greater than 3×10⁻³⁰ C·m.

24. The method of claim 23, wherein the co-solvent or ionic liquid comprises one or more of water, isopropanol, ethanol, methanol, butanol, formaldehyde, acetaldehyde, acetone, or diethyl ether.

25. The method of claim 1, further comprising mixing a reaction reagent into said supercritical solution.

26. The method of claim 25, wherein the reaction reagent is also used to reduce the surfaces of the conductive particles and to remove oxide contaminations from said surfaces.

27. The method of claim 25, wherein the reaction reagent comprises a reducing or oxidizing agent.

28. The method of claim 27, wherein the reducing or oxidizing agent comprises one or more of hydrogen, forming gas, methanol, ethanol, isopropanol, butanol, carbon monoxide, oxygen or water.

29. The method of claim 1, further comprising exposing the conductive particles to a reaction reagent in a separate stream from the supercritical solution.

30. The method of claim 1, further comprising premixing a reaction agent with the supercritical solution at conditions where a chemical reaction involving the precursor is slow.

31. The method of claim 1, further comprising alternating exposing the conductive particles to the supercritical solution and to a reaction reagent in a separate stream from the supercritical solution.

32. The method of claim 1, wherein the reactor comprises a fluidized bed reactor and wherein the supercritical solution flows into the reactor with a velocity sufficient to form a fluidized bed of the conductive particles.

33. The method of claim 1, wherein the reactor comprises a cross-flow moving bed reactor and wherein the supercritical solution flows into the reactor with a velocity sufficient to form a partially fluidized bed and wherein the partially fluidized bed is configured to continually move downward.

34. The method of claim 1, wherein the reactor comprises a continuous particle reactor and wherein a lock hopper is used to pressurize the conductive particles and drop them into a stream of the supercritical solution.

35. The method of claim 1, wherein the precursor and the supercritical fluid solvent form a combined stream and the combined stream is injected directly into the reactor.

36. The method of claim 1, further comprising providing a supercritical fluid handling manifold and wherein the dissolving of the precursor of the coating material into the supercritical fluid solvent occurs in the supercritical fluid handling manifold and wherein the supercritical fluid handling manifold is configured to generate a combined stream of the supercritical fluid solvent mixed with the supercritical solution of the precursor at a controlled ratio.

37. A method for depositing a thin film of chromium material onto a copper particle surface comprising:
providing copper particles;
providing a precursor of a chromium material;
dissolving the precursor of the chromium material into a supercritical fluid solvent to form a supercritical solution of the precursor; and subsequently
exposing the copper particles to said supercritical solution in a reactor under conditions at which supercritical fluid deposition of a thin film of the chromium material onto surfaces of the copper particles occurs.

38. A method for depositing a thin film of silver material onto a copper particle surface comprising:
providing copper particles;
providing a precursor of a silver material;
dissolving the precursor of the silver material into a supercritical fluid solvent to form a supercritical solution of the precursor; and subsequently
exposing the copper particles to said supercritical solution in a reactor under conditions at which supercritical fluid deposition of a thin film of the silver material onto surfaces of the copper particles occurs.
